(19) United States
(12) Patent Application Publication
(10) Pub. No.: US 2006/0146079 A1
(43) Pub. Date: Jul. 6, 2006

(54) Process and apparatus for forming an electronic device

(76) Inventors: Charles Douglas MacPherson, Santa Barbara, CA (US); Dennis Damon Walker, Santa Barbara, CA (US); Matthew Stainer, Goleta, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/026,043

(22) Filed: Dec. 30, 2004

(51) Int. Cl. B41J 29/38

(52) U.S. Cl. 347/9

(57) ABSTRACT

An apparatus includes a first continuous dispense nozzle and a chuck configured to receive a substrate for an electronic device. The first continuous dispense nozzle, the chuck, or both are configured to move along at least two different axes during a continuous dispense action.

### BACKGROUND OF THE INVENTION

1. Field of the Invention

This invention relates in general to processes for forming electronic devices and apparatus for performing such processes and more specifically, to processes for forming electronic devices including at least one organic layer and apparatuses for performing such processes.

2. Description of the Related Art

Manufacturers are increasingly turning to electronic devices that include organic electronic components, such as organic light emitting diodes (OLEDs). One type of organic electronic components includes an organic active layer located between two electrodes, an anode and a cathode. For display components, application of a potential across the electrodes results in excitation of the organic active layer and, as a result, emission of electromagnetic radiation, such as visible light. For sensor components, absorption of electromagnetic radiation by the organic active layer results in an electrical potential. Generally, organic electronic components are arranged in rows and several rows form a portion of the electronic devices.

However, traditional methods for producing electronic devices having organic electronic components, such as OLEDs, are costly. In part, this cost is derived from slow manufacturing methods, such as ink-jet printing. Typically, ink-jet printers dispense liquids as drops. A 40 pL drop can be used, but has a diameter of approximately 41 microns. Even when using state-of-the-art ink-jet technology, a 10 pL drop has a diameter of approximately 26 microns. In addition to having a limited ability to print fine lines, a printing head for an ink-jet printer moves at a rate no greater than approximately 0.1 m/s. A typical printing speed is approximately 0.064 m/s. As a result, ink-jet printing is time consuming, leading to limited throughput of devices.

Additionally, ink-jet printers are limited in their ability to print a wide variety of liquid compositions. For example, the solid concentration of a liquid composition is typically in a range of 0.5 to 1.5 weight percent, with viscosities between 5 and 15 centipoise within a printing head. At higher concentrations (e.g., viscosities at 15 centipoise and higher), the nozzle for the ink-jet printer has an increased likelihood of clogging or not flowing properly. At lower solids concentrations, too much volume needs to be dispensed resulting in poor line width control.

### SUMMARY OF THE INVENTION

An apparatus includes a first continuous dispense nozzle and a chuck configured to receive a substrate for an electronic device. The first continuous dispense nozzle, the chuck, or both are configured to move along at least two different axes during a continuous dispense action.

A process for forming an electronic device includes depositing a first line of a first liquid composition over a substrate for an electronic device, wherein depositing is performed using a continuous dispense nozzle, and wherein the continuous dispense nozzle and the substrate move relative to each other along at least two different axes during depositing.

An electronic device includes a substrate and a first layer overlying the substrate, wherein the first layer is oriented in a first line along a first curved path.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIGS. 1 and 3 include illustrations of side views of exemplary apparatuses for forming electronic components.

FIG. 2 includes an illustration of a perspective view of an exemplary apparatus for forming electronic components.

FIG. 4 includes an illustration of a top view of an exemplary apparatus for forming electronic components.

FIGS. 5, 6, 7, 8, 9, 10, and 11 include illustrations of plan views of 30 exemplary patterns that may be formed over a substrate using an apparatus, such as any of those illustrated in FIGS. 1, 2, 3, and 4.

FIGS. 12 and 13 include illustrations of a plan view and a cross-sectional view, respectively, of an exemplary electronic device.

### DETAILED DESCRIPTION

In one embodiment, an apparatus includes a first continuous dispense nozzle and a chuck configured to receive a substrate for an electronic device. The first continuous dispense nozzle, the chuck, or both are configured to move along at least two different axes during a continuous dispense action.

In one example, the at least two different axes are substantially parallel to a plane. The chuck may be configured to move the substrate bi-directionally along the at least two different axes. The chuck may be configured to tilt.

In another example, the continuous dispense action includes dispensing a liquid composition in a continuous stream. In an example, the apparatus is configured to deposit liquid composition in a line along a curved path.

In a further example, the apparatus includes a head assembly including the first continuous dispense nozzle. The head assembly may include a second continuous dispense nozzle. The head assembly may include a pivot mechanism.

In another embodiment, a process for forming an electronic device includes depositing a first line of a first liquid composition over a substrate for an electronic device, wherein depositing is performed using a continuous dispense nozzle, and wherein the continuous dispense nozzle and the substrate move relative to each other along at least two different axes during depositing. The at least two difference axes may be substantially perpendicular to each other and substantially parallel to a plane.

In one example, the process also includes moving the substrate bi-directionally along the at least two different axes during depositing. The process may also include depositing a second line to overlie the substrate. The first line may include a first organic active layer and the second line may include a second organic active layer that has a composition different from the first organic active layer.

In another example, the process further includes placing the substrate into a chuck, moving the chuck, and moving the continuous dispense nozzle. Depositing the first line, moving the chuck, and moving the continuous dispense nozzle may occur simultaneously. The process may further include pivoting the continuous dispense nozzle during printing.

Depositing may be performed at a travel velocity of at least about 100 cm/s relative to one of the at least two axes. The first line may be oriented along a curved path.

In a further embodiment, an electronic device includes a substrate and a first layer overlying the substrate, wherein the first layer is oriented in a first line along a first curved path.

In one example, a first electrode is located between the substrate and the first layer and the second electrode overlies the first layer. A second layer may overlie the substrate wherein the second layer is oriented in a second line along a second curved path. The first layer and the second layer may be organic active layers.

Other features and advantages of the invention will be apparent from the following detailed description, and from the claims. The detailed description first addresses Definitions and Clarification of Terms, followed by Apparatus Useful for Forming Electronic Devices, Liquid Compositions, Printing Lines, Electronic Devices and Methods of Forming Such Electronic Devices, and Advantages.

1. Definitions and Clarification of Terms

Before addressing details of embodiments described below, some terms are defined or clarified. The term “adjacent,” does not necessarily mean that a layer, member or structure is immediately next to another layer, member or structure. A combination of layer(s), member(s) or structure(s) that directly contact each other are still adjacent to each other.

The terms “array,” “peripheral circuitry” and “remote circuitry” are intended to mean different areas or components of the organic electronic device. For example, an array may include pixels, cells, or other structures within an orderly arrangement (usually designated by columns and rows). The pixels, cells, or other structures within the array may be controlled locally by peripheral circuitry, which may lie within the same organic electronic device as the array but outside the array itself. Remote circuitry typically lies away from the peripheral circuitry and can send signals to or receive signals from the array (typically via the peripheral circuitry). The remote circuitry may also perform functions unrelated to the array. The remote circuitry may or may not reside on the substrate having the array.

The term “bidirectional” is intended to refer to movement in both directions along a given axis.

The term “charge-blocking,” when referring to a layer, material, member, or structure, is intended to mean such layer, material, member or structure significantly reduces the likelihood that a charge intermixes with another layer, material, member or structure.

The term “charge-injecting,” when referring to a layer, material, member, or structure, is intended to mean such layer, material, member or structure promotes charge migration into an adjacent layer, material, member or structure.

The term “charge-transport,” when referring to a layer, material, member or structure, is intended to mean such layer, material, member or structure facilitates migration of such charge through the thickness of such layer, material, member or structure with relative efficiency and small loss of charge.

The term “chuck” is intended to mean a mechanism for supporting, holding, or retaining a substrate or a workpiece. The chuck may include one or more pieces. In one embodiment, the chuck may include a combination of a stage and an insert, a platform, another similar component, or any combination thereof.

The term “continuous” and its variants are intended to mean substantially unbroken. In one embodiment, continuously printing is printing using a substantially unbroken stream of a liquid or a liquid composition, as opposed to a depositing technique using drops. In another embodiment, extending continuously refers to a length of a layer, member, or structure in which no significant breaks in the layer, member, or structure lie along its length.

The term “electronic component” is intended to mean a lowest level unit of a circuit that performs an electrical or electro-radiative (e.g., electro-optic) function. An electronic component may include a transistor, a diode, a resistor, a capacitor, an inductor, a semiconductor laser, an optical switch, or the like. An electronic component does not include parasitic resistance (e.g., resistance of a wire) or parasitic capacitance (e.g., capacitive coupling between two conductors connected to different electronic components where a capacitor between the conductors is unintended or incidental).

The term “electronic device” is intended to mean a collection of circuits, electronic components, or combinations thereof that collectively, when properly connected and supplied with the appropriate potential(s), performs a function. An electronic device may include or be part of a system. An example of an electronic device include a display, a sensor array, a computer system, an avionics system, an automobile, a cellular phone, another consumer or industrial electronic product, or the like.

The terms “height,” “length,” and “width,” when referring to a structure overlying a substrate, are intended to refer to dimensions substantially perpendicular to each other. “Height” is intended to refer to a distance above an underlying substrate. “Length” is intended to refer to a dimension within a plane substantially parallel to the substrate. “Width” is intended to refer to a dimension within a plane substantially parallel to the substrate and substantially perpendicular to the “length” dimension. In one embodiment, the “width” is shorter than the “length.”

The term “line,” when referring to printing over a substrate, is intended to mean an unbroken geometric element as seen by a plan view of the substrate. Note that a line may or may not have sharp angles.

The term “liquid composition” is intended to mean a material that is dissolved in a liquid medium to form a solution, dispersed in a liquid medium to form a dispersion, or suspended in a liquid medium to form a suspension or an emulsion.

The term “nozzle” is intended to mean a portion of an apparatus through which a liquid composition or liquid medium can be dispensed.

The term “opening” is intended to mean an area characterized by the absence of a particular structure that surrounds the area, as viewed from the perspective of a plan view.

The term “organic active layer” is intended to mean one or more organic layers, wherein at least one of the organic layers, by itself, or when in contact with a dissimilar material is capable of forming a rectifying junction.

The term “overlying” does not necessarily mean that a layer, member, or structure is immediately next to or in contact with another layer, member, or structure.

The term “pivoting mechanism” is intended to mean an apparatus or portion thereof for rotating an object or portion thereof about a fixed point.

The term “rectifying junction” is intended to mean a junction within a semiconductor layer or a junction formed by an interface between a semiconductor layer and a dissimilar material, in which charge carriers of one type flow easier in one direction through the junction compared to the opposite direction. A pn junction is an example of a rectifying junction that can be used as a diode.

The term “structure” is intended to mean one or more patterned layers or members, which by itself or in combination with other patterned layer(s) or member(s), forms a unit that serves an intended purpose. Examples of structures include electrodes, well structures, cathode separators, and the like.

The term “substantially parallel” is intended to mean that the orientations of a combination of one or more lines, one or more vectors, or one or more planes are parallel or almost parallel such that any skewness is considered to be insignificant to one of ordinary skill in the art.

The term “substantially perpendicular” is intended to mean that orientations of a combination of one or more lines, one or more vectors, or one or more planes are perpendicular or almost perpendicular such that any angular difference from perpendicular is considered to be insignificant to one of ordinary skill in the art.

The term “substrate” is intended to mean a base material that can be either rigid or flexible and may include one or more layers of one or more materials, which can include glass, polymer, a metal or ceramic material, or any combination thereof. The reference point for a substrate is the beginning point of a process sequence. The substrate may or may not include electronic components, circuits, or conductive members.

The term “travel velocity” is intended to mean a rate of movement along a given axis.

The term “vector” when associated with an array is intended to mean a row, column, or diagonal line.

The term “well structure” is intended to mean a structure overlying a substrate, wherein the structure serves a principal function of separating an object, a region, or any combination thereof within or overlying the substrate from contacting a different object or different region within or overlying the substrate.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, for clarity purposes and to give a general sense of the scope of the embodiments described herein, the use of the “a” or “an” are employed to describe one or more articles to which “a” or “an” refers. Therefore, the description should be read to include one or at least one whenever “a” or “an” is used, and the singular also includes the plural unless it is clear that the contrary is meant otherwise.

Group numbers corresponding to columns within the Periodic Table of the elements use the “New Notation” convention as seen in the CRC Handbook of Chemistry and Physics, 81^{st} Edition (2000).

Unless otherwise defined, all technical and scientific terms used herein have the same meaning as commonly understood by one of ordinary skill in the art to which this invention belongs. Although suitable methods and materials are described herein for embodiments of the invention, or methods for making or using the same, other methods and materials similar or equivalent to those described can be used without departing from the scope of the invention. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

To the extent not described herein, many details regarding specific materials, processing acts, and circuits are conventional and may be found in textbooks and other sources within the organic light-emitting diode display, photodetector, photovoltaic, and semiconductor arts.

2. Apparatus Useful for Forming Electronic Device

A printing apparatus can be used to print a layer over nearly any substrate during the formation of an electronic device. FIG. 1 includes a side view of a printing apparatus 200 that can be used to continuously print a layer that will be used within an electronic device. The printing apparatus 200 includes an enclosure 202, which encloses a space 204, a printing head assembly 244 including a nozzle 245, and a chuck 222. The chuck 222 is configured to support, hold, or retain a workpiece (not illustrated in FIG. 1) on or within which electronic components can be formed.

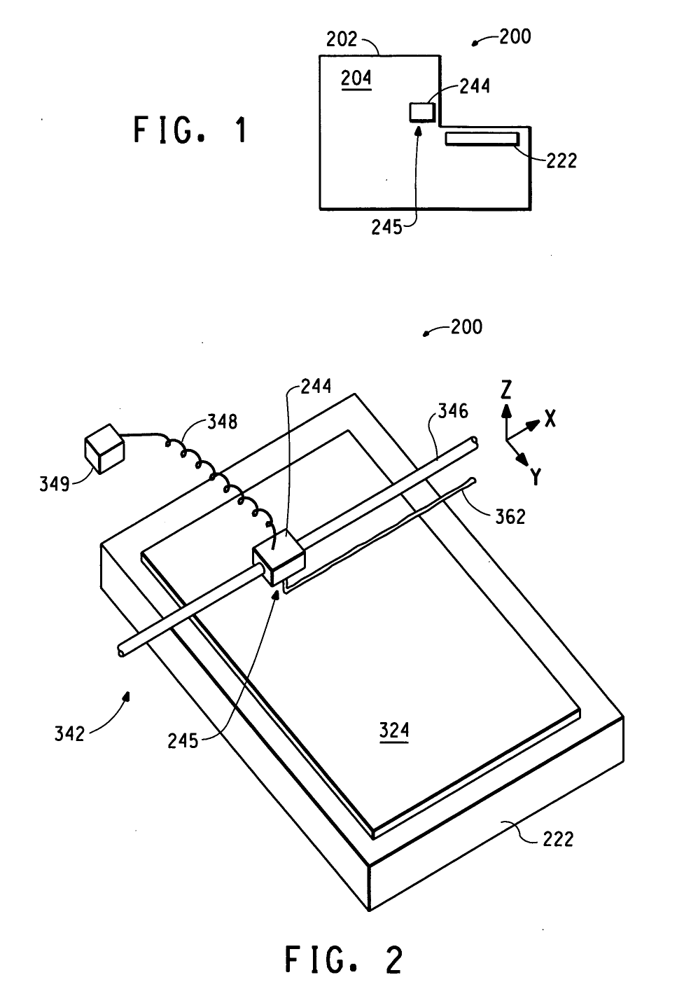

FIG. 2 includes an illustration of a perspective view of the printing apparatus 200 and a workpiece 324 during a printing operation. The chuck 222 supports, holds, or retains the workpiece 324. The workpiece 324 can be held in place by clamps or pins, by one or more adhesive films, by vacuum, electrostatically, or any combination thereof. In one embodiment, the chuck 222 is configured to move in the y-direction as illustrated in FIG. 2. The printing apparatus 200 includes a printing assembly 342 including the printing head assembly 244, an air bearing 346, and the nozzle 245. The printing head assembly 244 may traverse the air bearing 346 in the x-direction as illustrated in FIG. 3. The printing apparatus 200 further includes a container 349 that is fluidly coupled to the printing head assembly 244 via a feed line 348. The feed line 348 provides one or more liquids or liquid compositions from the container 349 to the printing head assembly 244. In one embodiment, more than one feed line 348, more than one container 349, or any combination thereof can be connected to the printing head assembly 244. Additional equipment may reside within or be used with the printing apparatus 200 but is not illustrated. Such other equipment can include any one or more stepper motors, pumps, filters, air handling equipment, control electronics, other electrical, mechanical, or electromechanical assemblies or subassemblies, facilities connections, or any combination thereof. A line 362 is printed on the workpiece 324 and a portion of the chuck 222 as illustrated in FIG. 2. The line 362 may be straight, curved, or include sharp angles. The printing operation and options available during printing will be described later in this specification.

Many options are available for the movement of the chuck 222, the printing head assembly 244, or both. The chuck 222 can move bi-directionally along one or more axes during printing. For example, the chuck 222 can move bi-directionally along the x-axis, y-axis, z-axis, or any combination thereof. The axis references are illustrated in FIG. 2. In one embodiment, each of the x-axis, y-axis, and z-axis is substantially perpendicular to the other two axes. The primary surface of the workpiece 324 is substantially parallel to a plane defined by the x-axis and y-axis. In one embodiment, the printing head assembly 244, the chuck 222, or both are configured to allow motion along two different axes during a continuous dispense action, such as continuously printing of a liquid composition. In one specific embodiment, printing the line 362 over the substrate is performed while the printing head moves at a rate at least approximately 100 cm/s relative to at least one of the axes. For example, the print head may move at a rate at least about 1 m/s. In one specific example, the print head moves at a rate in a range of 2 to 3 m/s. In another specific example, the print head moves at a rate at least about 6 m/s.

The chuck 222 may also allow rotation about an axis or allow the workpiece 324 to be inclined, declined, or both compared to a reference plane, such as the floor of the room in which the printing apparatus 200 resides, such as to position 380, as illustrated in FIG. 3. In one exemplary embodiment, the chuck 222 is configured to tilt the workpiece (not illustrated) relative to a horizontal plane. For example, the chuck 222 can be configured to move the substrate along two axes during a continuous dispense and can be configured to tilt the substrate out of a plane substantially parallel to the two axes.

The chuck 222 may be configured to tilt the workpiece prior to, during, or after a continuous dispense action. In one exemplary embodiment, tilting of the substrate during the continuous dispense action results in the spreading or broadening of a line that results from the continuous stream 370 of liquid composition. In an alternative embodiment, surface structures may be configured to catch the liquid composition that is continuously dispensed, such as overhanging substrate structures or well structures.

The printing head assembly 244 may or may not also move in any of those directions. When dispensing more than one liquid composition during a single printing action or when overlaying subsequent lines over the workpiece 324 during subsequent printing actions, the orientation of the nozzle 245, when printing, can affect the relative distance between the concurrently dispensed lines, the previously dispensed lines, or any combination thereof.

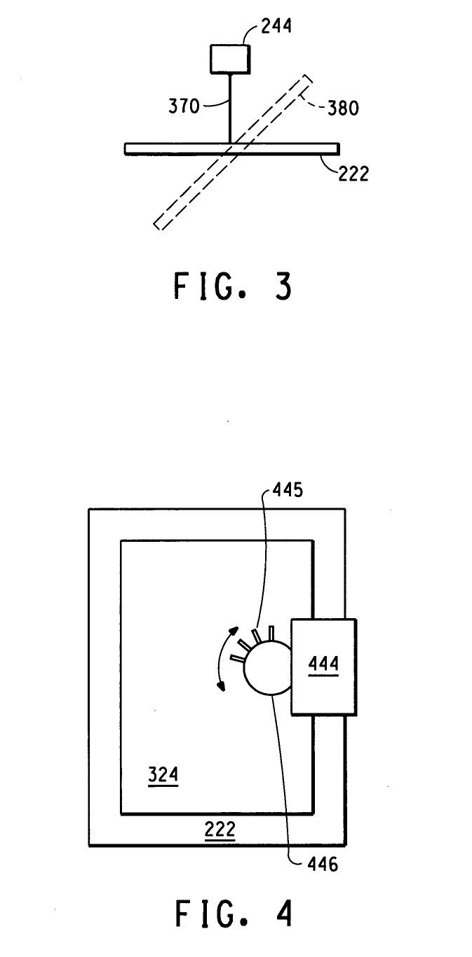

FIG. 4 includes an illustration of a top view of a printing apparatus that has a pivoting printing head assembly 444. A printing head assembly 444 includes one nozzle or a set of nozzles 445 for printing one or more liquid compositions over the workpiece 324, which is supported, held, or retained by the chuck 222. In this exemplary embodiment, the nozzles 445 are attached to a pivoting mechanism 446. In one embodiment, the pivoting mechanism 446 is configured to move or rotate the nozzles 445 such that the alignment of the nozzles 445 changes relative to a horizontal plane, such as an x-y plane substantially parallel to the primary surface of the workpiece 324. in one embodiment, the pivoting mechanism 446 can rotate the nozzles 445 before, during, or after printing lines on the workpiece 324.

Note that the printing assembly 342 may be modified so that other equipment may be used in place of or in conjunction with the air bearing 346 to allow such motion. For example, the printing assembly 342 may include a gantry to allow motion along the x-axis and y-axis. In one embodiment, the workpiece 324 remains stationary during printing. One or both of the printing head assembly 244 and the chuck 222 may move before, during, or after printing. In one embodiment, the printing head assembly 244 and chuck 222 can be moved simultaneously. Nearly any movement of the chuck 222 or the printing head assembly 244, or nearly any relative motion between the chuck 222 and the printing head assembly 244 is possible.

The nozzle 245 can be an orifice with nearly any shape (e.g., circular, rectangular, etc.). For simplicity, the orifice is typically circular. In theory, the orifice may be nearly any size. Practical considerations may limit the size of the orifice. For example, the narrowest dimension to be printed may limit the size of the orifice. In one embodiment, the orifice has a width no greater than the narrowest dimension to be printed. In another embodiment, the orifice has a diameter in a range of approximately 5 to 30 microns, such as in a range of approximately 10 to 20 microns.

In another embodiment, the nozzle 245 can be a slot. A slot-shaped opening can be used for one or more layers that may be blanket deposited over a substrate or a portion thereof (e.g., an array for the electronic device). In one embodiment, the slot has a width in a range of approximately 5 to 30 microns and a length substantially the same dimension or longer than the corresponding dimension of the substrate or the portion thereof printed using the nozzle 245 with the slot-shaped opening. Such an embodiment can be useful for depositing a buffer layer, a charge-blocking layer, a charge-injecting layer, a charge-transport layer, or a combination thereof.

During printing, the pressure within the printing head assembly 244 can be in a range of approximately 100 to 350 kPa. The flow rate of liquid or a liquid composition from the printing head assembly 244 can be in a range of 50 to 600 microliters per minute. In other embodiments, a higher or lower pressure, a higher or lower flow rate, or any combination thereof can also be used. After reading the specification, skilled artisans will be able to adjust or modify the printing apparatus 200 to achieve pressures and flow rates for their particular applications.

The printing head assembly 244, 444, or both can use a simpler design as compared to printing heads used for ink-jet printers. The simpler design allows a wider array of materials to be used within the printing head assembly 244, 444, or both. For example, the printing head can use one or more plastic or polymer materials, such as polyetherketone, TEFLON® brand compound (E.I. DuPont de Nemours and Company) or other polyfluorocarbon compound, one or more metallic materials, such as stainless steel, copper, brass, MONEL™ brand (Cu—Ni) alloy, one or more ceramic materials, including glass, Si₃N₄, Al₂O₃, AlN, or any combination thereof. The printing head assembly 244, 444, or both do not require the use of corrosive nickel-containing components, epoxy, or both, which are found in conventional ink-jet printing heads. After reading this specification, skilled artisans will be able to determine which material(s) based on the liquid composition that will be dispensed. For example, with an organic active layer, a nickel-containing compound may be avoided.

Any one or more of the chuck 224, the printing head assembly 244, the feed line 348, the container 349, other part(s) of the printing apparatus 200, or any combination thereof can include one or more temperature adjusting elements to raise the temperature, lower the temperature, or maintain the temperature of a local or larger area within the printing apparatus 200.

The ability to use different temperatures allows a wider range of materials, properties, or both to be used. In one embodiment, the viscosity of the liquid composition can be raised or lowered within the printing head assembly 244, the feed line 348, the container 349 or other part(s) of the printing apparatus 200, the viscosity of the liquid composition can be raised or lowered at the workpiece 324 by adjusting the temperature of the chuck 224, or any combination thereof. Additionally, boiling points for the liquid medium for the liquid composition can be outside the conventional limits seen with ink-jet printing. For example, cooling the liquid composition within the printing head assembly 244, the feed line 348, the container 349, other part(s) of the printing apparatus 200 may allow a liquid medium to be used that would otherwise have too low of a boiling point. Alternatively, heating the liquid composition within the printing head assembly 244, the feed line 348, the container 349, or other part(s) of the printing apparatus 200 may allow a liquid medium to be used that would otherwise have too high of a viscosity if at an ambient temperature. Heating or cooling the chuck 224 can affect viscosity directly or indirectly (by evaporating the liquid medium of the liquid composition) to allow a wider variety of liquid compositions (including liquid medium) to be used.

In one embodiment, a temperature difference can be created or maintained between a liquid composition, which is dispensed through the printing head assembly 244, and the workpiece 324. In one embodiment, the workpiece 324 is hotter than the liquid composition just before reaching the workpiece 324, or vice versa. In another embodiment, the temperature difference can be used to allow a viscosity of a liquid composition to increase quicker than under ambient conditions. In another embodiment, the temperature difference can allow the printed lines to dry more quickly, such that the liquid composition has a viscosity that increases relatively quickly and keeps the width of the line being printed smaller than can otherwise be obtained without the temperature difference. In still another embodiment, the temperature difference may allow the chuck to be relatively cooler than the liquid composition. In this embodiment, the vapor pressure from the printed segments can allow for a more uniform layer of vapor to reside above the printed segments and may allow for more uniform drying conditions between segments. In other embodiments, the temperature difference can be used for any one or more other reasons or for any combination of reasons.

3. Liquid Compositions

The printing apparatus, such as an apparatus illustrated in any of FIGS. 1, 2, 3 or 4, can be used to deposit a variety of different materials, including liquid compositions. The following paragraphs include only some but not all of the materials that may be used. In one embodiment, one or more materials for an organic layer within an electronic device are formed using the printing apparatus. The organic layer can include an organic active layer, (e.g., a radiation-emitting organic active layer or a radiation-responsive organic active layer), filter layer, charge injection layer, charge transport layer, charge blocking layer, or any combination thereof. The organic layer may be used as part of a resistor, transistor, capacitor, diode, etc.

The printing apparatus is well suited for printing liquid compositions. The liquid composition can be in the form of a solution, dispersion, emulsion, or suspension. In the paragraphs that follow, non-limiting examples of solid materials and liquid media are given. The solid material(s) can be selected upon the electronic or electro-radiative properties for a subsequently formed layer. The liquid medium (media) can be selected based on criteria described later in this specification.

For a radiation-emitting organic active layer, suitable radiation-emitting materials include one or more small molecule materials, one or more polymeric materials, or a combination thereof. A small molecule material may include any one or more of those described in, for example, U.S. Pat. No. 4,356,429 (“Tang”); U.S. Pat. No. 4,539,507 (“Van Slyke”); U.S. Patant Application Publication No. US 2002/0121638 (“Grushin”); or U.S. Pat. No. 6,459,199 (“Kido”). Alternatively, a polymeric material may include any one or more of those described in U.S. Pat. No. 5,247,190 (“Friend”); U.S. Pat. No. 5,408,109 (“Heeger”); or U.S. Pat. No. 5,317,169 (“Nakano”). An exemplary material is a semiconducting conjugated polymer. An example of such a polymer includes poly(paraphenylenevinylene) (PPV), a PPV copolymer, a polyfluorene, a polyphenylene, a polyacetylene, a polyalkylthiophene, poly(n-vinylcarbazole) (PVK), or the like. In one specific embodiment, a radiation-emitting active layer without any guest material may emit blue light.

For a radiation-responsive organic active layer, a suitable radiation-responsive material may include many a conjugated polymer or an electroluminescent material. Such a material includes, for example, a conjugated polymer or an electro- and photo-luminescent material. A specific example includes poly(2-methoxy,5-(2-ethyl-hexyloxy)-1,4-phenylene vinylene) (“MEH-PPV”) or a MEH-PPV composite with CN-PPV.

The location of a filter layer may be between an organic active layer and a user side of the electronic device. A filter layer may be part of a substrate, an electrode (e.g., an anode or a cathode), a charge-transport layer, a charge-injecting layer, or a charge-blocking layer; the filter layer may lie between any one or more of the substrate, an electrode, a charge-transport layer, a charge-injecting layer, a charge-blocking layer, or any combination thereof; or any combination thereof. In another embodiment, the filter layer may be a layer that is fabricated separately (while not attached to the substrate) and later attached to the substrate at any time before, during, or after fabricating the electronic components within the electronic device. In this embodiment, the filter layer may lie between the substrate and a user of the electronic device.

When the filter layer is separate from or part of the substrate, or when the filter lies between the substrate and an electrode closest to the substrate, a suitable material includes an organic material including a polyolefin (e.g., polyethylene or polypropylene); a polyester (e.g., polyethylene terephthalate or polyethylene naphthalate); a polyimide; a polyamide; a polyacrylonitrile or a polymethacrylonitrile; a perfluorinated or partially fluorinated polymer (e.g., polytetrafluoroethylene or a copolymer of tetrafluoroethylene and polystyrene); a polycarbonate; a polyvinyl chloride; a polyurethane; a polyacrylic resin, including a homopolymer or a copolymer of an ester of an acrylic or methacrylic acid; an epoxy resin; a Novolac resin; or any combination thereof.

For a hole-injecting layer, hole-transport layer, electron-blocking layer, or any combination thereof, a suitable material includes polyaniline (“PANI”), poly(3,4-ethylenedioxythiophene) (“PEDOT”), polypyrrole, an organic charge transfer compound, such as tetrathiafulvalene tetracyanoquinodimethane (“TTF-TCQN”), a hole-transport material as described in Kido, or any combination thereof.

For an electron-injecting layer, electron transport layer, hole-blocking layer, or any combination thereof, a suitable material includes a metal-chelated oxinoid compound (e.g., Alq₃ or aluminum(III)bis(2-methyl-8-quinolinato)4-phenylphenolate (“BAlq”)); a phenanthroline-based compound (e.g., 2,9-dimethyl-4,7-diphenyl-1,10-phenanthroline (“DDPA”) or 9,10-diphenylanthracence (“DPA”)); an azole compound (e.g., 2-tert-butylphenyl-5-biphenyl-1,3,4-oxadiazole (“PBD”) or 3-(4-biphenyl)-4-phenyl-5-(4-t-butylphenyl)-1,2,4-triazole (“TAZ”); an electron transport material as described in Kido; a diphenylanthracene derivative; a dinaphthylanthracene derivative; 4,4-bis(2,2-diphenyl-ethen-1-yl)-biphenyl (“DPVBI”); 9,10-di-beta-naphthylanthracene; 9,10-di-(naphenthyl)anthracene; 9,10-di-(2-naphthyl)anthracene (“ADN”); 4,4′-bis(carbazol-9-yl)biphenyl (“CBP”); 9,10-bis-[4-(2,2-diphenylvinyl)-phenyl]-anthracene (“BDPVPA”); anthracene, N-arylbenzimidazoles (such as “TPBI”); 1,4-bis[2-(9-ethyl-3-carbazoyl)vinylenyl]benzene; 4,4′-bis[2-(9-ethyl-3-carbazoyl)vinylenyl]-1,1′-biphenyl; 9,10-bis[2,2-(9,9-fluorenylene)vinylenyl]anthracene; 1,4-bis[2,2-(9,9-fluorenylene)vinylenyl]benzene; 4,4′-bis[2,2-(9,9-fluorenylene)vinylenyl]-1,1′-biphenyl; perylene, substituted perylenes; tetra-tert-butylperylene (“TBPe”); bis(3,5-difluoro-2-(2-pyridyl)phenyl-(2-carboxypyridyl) iridium III (“F(lr)Pic”); a pyrene, a substituted pyrene; a styrylamine; a fluorinated phenylene; oxidazole; 1,8-naphthalimide; a polyquinoline; one or more carbon nanotubes within PPV; or any combination thereof.

For an electronic component, such as a resistor, transistor, capacitor, etc., the organic layer may include one or more of thiophenes (e.g., polythiophene, poly(alkylthiophene), alkylthiophene, bis(dithienthiophene), alkylanthradithiophene, etc.), polyacetylene, pentacene, phthalocyanine, or any combination thereof.

An example of an organic dye includes 4-dicyanmethylene-2-methyl-6-(p-dimethyaminostyryl)-4H-pyran (DCM), coumarin, pyrene, perylene, rubrene, a derivative thereof, or any combination thereof.

An example of an organometallic material includes a functionalized polymer comprising one or more functional groups coordinated to at least one metal. An exemplary functional group contemplated for use includes a carboxylic acid, a carboxylic acid salt, a sulfonic acid group, a sulfonic acid salt, a group having an OH moiety, an amine, an imine, a diimine, an N-oxide, a phosphine, a phosphine oxide, a β-dicarbonyl group, or any combination thereof. An exemplary metal contemplated for use includes a lanthanide metal (e.g., Eu, Tb), a Group 7 metal (e.g., Re), a Group 8 metal (e.g., Ru, Os), a Group 9 metal (e.g., Rh, Ir), a Group 10 metal (e.g., Pd, Pt), a Group 11 metal (e.g., Au), a Group 12 metal (e.g., Zn), a Group 13 metal (e.g., Al), or any combination thereof. Such an organometallic material includes a metal chelated oxinoid compound, such as tris(8-hydroxyquinolato)aluminum (Alq₃); a cyclometalated iridium or platinum electroluminescent compound, such as a complex of iridium with phenylpyridine, phenylquinoline, or phenylpyrimidine ligands as disclosed in published PCT Application WO 02/02714, an organometallic complex described in, for example, published applications US 2001/0019782, EP 1191612, WO 02/15645, WO 02/31896, and EP 1191614; or any mixture thereof.

An example of a conjugated polymer includes a poly(phenylenevinylene), a polyfluorene, a poly(spirobifluorene), a copolymer thereof, or any combination thereof.

Selecting a liquid medium can also be an important factor for achieving one or more proper characteristics of the liquid composition. A factor to be considered when choosing a liquid medium includes, for example, viscosity of the resulting solution, emulsion, suspension, or dispersion, molecular weight of a polymeric material, solids loading, type of liquid medium, boiling point of the liquid medium, temperature of an underlying substrate, thickness of an organic layer that receives a guest material, or any combination thereof

In some embodiments, the liquid medium includes at least one solvent. An exemplary organic solvent includes a halogenated solvent, a colloidal-forming polymeric acid, a hydrocarbon solvent, an aromatic hydrocarbon solvent, an ether solvent, a cyclic ether solvent, an alcohol solvent, a glycol solvent, a ketone solvent, a nitrile solvent, a sulfoxide solvent, an amide solvent, or any combination thereof.

An exemplary halogenated solvent includes carbon tetrachloride, methylene chloride, chloroform, tetrachloroethylene, chlorobenzene, bis(2-chloroethyl)ether, chloromethyl ethyl ether, chloromethyl methyl ether, 2-chloroethyl ethyl ether, 2-chloroethyl propyl ether, 2-chloroethyl methyl ether, or any combination thereof.

An exemplary colloidal-forming polymeric acid includes a fluorinated sulfonic acid (e.g., fluorinated alkylsulfonic acid, such as perfluorinated ethylenesulfonic acid) or any combinations thereof.

An exemplary hydrocarbon solvent includes pentane, hexane, cyclohexane, heptane, octane, decahydronaphthalene, a petroleum ether, ligroine, or any combination thereof.

An exemplary aromatic hydrocarbon solvent includes benzene, naphthalene, toluene, xylene, ethyl benzene, cumene (iso-propyl benzene) mesitylene (trimethyl benzene), ethyl toluene, butyl benzene, cymene (iso-propyl toluene), diethylbenzene, iso-butyl benzene, tetramethyl benzene, sec-butyl benzene, tert-butyl benzene, anisole, 4-methylanisole, 3,4-dimethylanisole, or any combination thereof.

An exemplary ether solvent includes diethyl ether, ethyl propyl ether, dipropyl ether, diisopropyl ether, dibutyl ether, methyl t-butyl ether, glyme, diglyme, benzyl methyl ether, isochroman, 2-phenylethyl methyl ether, n-butyl ethyl ether, 1,2-diethoxyethane, sec-butyl ether, diisobutyl ether, ethyl n-propyl ether, ethyl isopropyl ether, n-hexyl methyl ether, n-butyl methyl ether, methyl n-propyl ether, or any combination thereof.

An exemplary cyclic ether solvent includes tetrahydrofuran, dioxane, tetrahydropyran, 4 methyl-1,3-dioxane, 4-phenyl-1,3-dioxane, 1,3-dioxolane, 2-methyl-1,3-dioxolane, 1,4-dioxane, 1,3-dioxane, 2,5-dimethoxytetrahydrofuran, 2,5-dimethoxy-2,5-dihydrofuran, or any combination thereof.

An exemplary alcohol solvent includes methanol, ethanol, 1-propanol, 2-propanol, 1-butanol, 2-butanol, 2-methyl-1-propanol (i.e., iso-butanol), 2-methyl-2-propanol (i.e., tert-butanol), 1-pentanol, 2-pentanol, 3-pentanol, 2,2-dimethyl-1-propanol, 1-hexanol, cyclopentanol, 3-methyl-1-butanol, 3-methyl-2-butanol, 2-methyl-1-butanol, 2,2-dimethyl-1-propanol, 3-hexanol, 2-hexanol, 4-methyl-2-pentanol, 2-methyl-1-pentanol, 2-ethylbutanol, 2,4-dimethyl-3-pentanol, 3-heptanol, 4-heptanol, 2-heptanol, 1-heptanol, 2-ethyl-1-hexanol, 2,6-dimethyl-4-heptanol, 2-methylcyclohexanol, 3-methylcyclohexanol, 4-methylcyclohexanol, or any combination thereof.

An alcohol ether solvent may also be employed. An exemplary alcohol ether solvent includes 1-methoxy-2-propanol, 2-methoxyethanol, 2-ethoxyethanol, 1-methoxy-2-butanol, ethylene glycol monoisopropyl ether, 1-ethoxy-2-propanol, 3-methoxy-1-butanol, ethylene glycol monoisobutyl ether, ethylene glycol mono-n-butyl ether, 3-methoxy-3-methylbutanol, ethylene glycol mono-tert-butyl ether, or any combination thereof.

An exemplary glycol solvent includes ethylene glycol, propylene glycol, propylene glycol monomethyl ether (PGME), dipropylene glycol monomethyl ether (DPGME), or any combination thereof.

An exemplary ketone solvent includes acetone, methylethyl ketone, methyl iso-butyl ketone, cyclohexanone, isopropyl methyl ketone, 2-pentanone, 3-pentanone, 3-hexanone, diisopropyl ketone, 2-hexanone, cyclopentanone, 4-heptanone, iso-amyl methyl ketone, 3-heptanone, 2-heptanone, 4-methoxy-4-methyl-2-pentanone, 5-methyl-3-heptanone, 2-methylcyclohexanone, diisobutyl ketone, 5-methyl-2-octanone, 3-methylcyclohexanone, 2-cyclohexen-1-one, 4-methylcyclohexanone, cycloheptanone, 4-tert-butylcyclohexanone, isophorone, benzyl acetone, or any combination thereof.

An exemplary nitrile solvent includes acetonitrile, acrylonitrile, trichloroacetonitrile, propionitrile, pivalonitrile, isobutyronitrile, n-butyronitrile, methoxyacetonitrile, 2-methylbutyronitrile, isovaleronitrile, N-valeronitrile, n-capronitrile, 3-methoxypropionitrile, 3-ethoxypropionitrile, 3,3′-oxydipropionitrile, n-heptanenitrile, glycolonitrile, benzonitrile, ethylene cyanohydrin, succinonitrile, acetone cyanohydrin, 3-n-butoxypropionitrile, or any combination thereof.

An exemplary sulfoxide solvent includes dimethyl sulfoxide, di-n-butyl sulfoxide, tetramethylene sulfoxide, methyl phenyl sulfoxide, or any combinations thereof.

An exemplary amide solvent includes dimethyl formamide, dimethyl acetamide, acylamide, 2-acetamidoethanol, N, N-dimethyl-m-toluamide, trifluoroacetamide, N,N-dimethylacetamide, N,N-diethyidodecanamide, epsilon-caprolactam, N,N-diethylacetamide, N-tert-butylformamide, formamide, pivalamide, N-butyramide, N,N-dimethylacetoacetamide, N-methyl formamide, N,N-diethylformamide, N-formylethylamine, acetamide, N,N-diisopropylformamide, 1-formylpiperidine, N-methylformanilide, or any combinations thereof.

A crown ether contemplated includes any one or more crown ethers that can function to assist in the reduction of the chloride content of an epoxy compound starting material as part of the combination being treated according to the invention. An exemplary crown ether includes benzo-15-crown-5; benzo-18-crown-6; 12-crown-4; 15-crown-5; 18-crown-6; cyclohexano-15-crown-5; 4′,4″(5″)-ditert-butyldibenzo-18-crown-6; 4′,4″(5″)-ditert-butyldicyclohexano-18-crown-6; dicyclohexano-18-crown-6; dicyclohexano-24-crown-8; 4′-aminobenzo-15-crown-5; 4′-aminobenzo-18-crown-6; 2-(aminomethyl)-15-crown-5; 2-(aminomethyl)-18-crown-6; 4′-amino-5′-nitrobenzo-15-crown-5; 1-aza-12-crown-4; 1-aza-15-crown-5; 1-aza-18-crown-6; benzo-12-crown-4; benzo-15-crown-5; benzo-18-crown-6; bis((benzo-15-crown-5)-15-ylmethyl)pimelate; 4-bromobenzo-18-crown-6; (+)-(18-crown-6)-2,3,11,12-tetra-carboxylic acid; dibenzo-18-crown-6; dibenzo-24-crown-8; dibenzo-30-crown-10; ar-ar′-di-tert-butyldibenzo-18-crown-6; 4′-formylbenzo-15-crown-5; 2-(hydroxymethyl)-12-crown-4; 2-(hydroxymethyl)-15-crown-5; 2-(hydroxymethyl)-18-crown-6; 4′-nitrobenzo-15-crown-5; poly-[(dibenzo-18-crown-6)-co-formaldehyde]; 1,1-dimethylsila-11-crown-4; 1,1-dimethylsila-14-crown-5; 1,1-dimethylsila-17-crown-5; cyclam; 1,4,10,13-tetrathia-7,16-diazacyclooctadecane; porphines; or any combination thereof.

In another embodiment, the liquid medium includes water. A conductive polymer complexed with.a water-insoluble colloid-forming polymeric acid can be deposited over a substrate and used as a charge-transport layer.

Many different classes of liquid medium (e.g., halogenated solvents, hydrocarbon solvents, aromatic hydrocarbon solvents, water, etc.) are described above. Mixtures of more than one of the liquid medium from different classes may also be used.

The liquid composition may also include an inert material, such as a binder material, a filler material, or a combination thereof. With respect to the liquid composition, an inert material does not significantly affect the electronic, radiation emitting, or radiation responding properties of a layer that is formed by or receives at least a portion of the liquid composition.

4. Printing Lines

The wide variety of configurations of the printing apparatus 200, the liquid compositions, the workpieces and their associated layers and structures, and the operating parameters for the printing apparatus 200 provide a nearly endless array of options available to users to print one or more lines for one or more layers that can be used in an electronic device.

FIGS. 2 and 5 to 11 illustrate patterns of some of the lines that can be formed using the printing apparatus 200. In FIG. 2, the line 362 can be straight and substantially parallel to the x-axis. In one embodiment, the chuck 222 moves bi-directionally in the y-direction, and the printing head assembly 244 moves bi-directionally in the x-axis. The chuck 222 can be positioned to the correct y-direction position using a conventional stepper motor. After the chuck 222 stops and upon supplying proper signal(s) to the printing head assembly 244, the line 362 is printed onto the workpiece 324. Note that the line 362 may be printed over a portion of the chuck 222. In an alternative embodiment, the line 362 may only be printed on the workpiece 324 or may be extended to print onto the chuck 222 at a location on an opposite side of the workpiece 324.

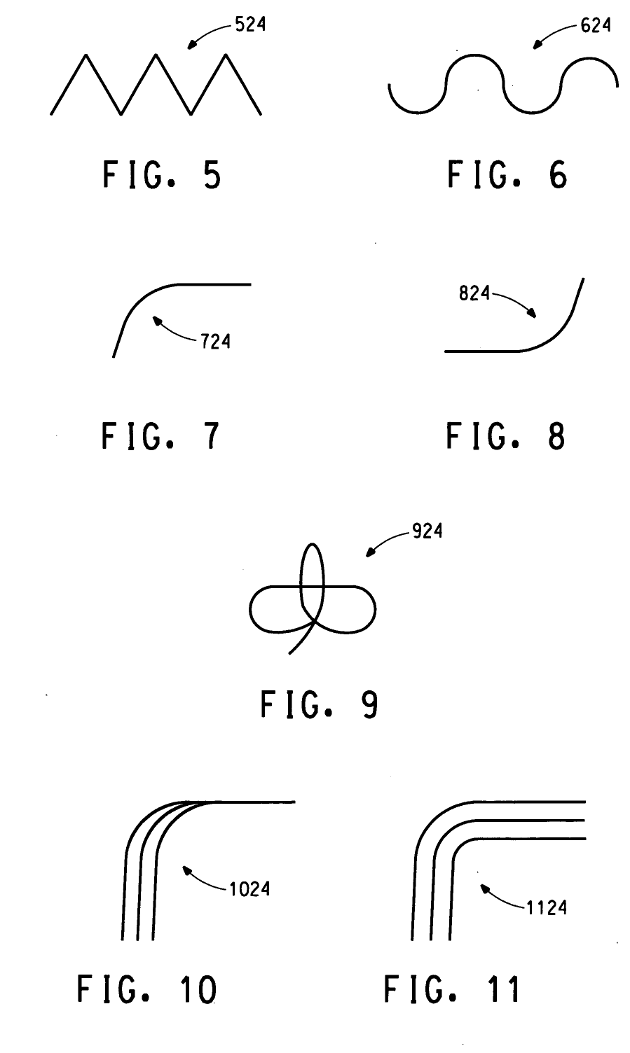

The chuck 222, printing head assembly 244, or both may or may not have its (their) movement restricted. As previously described, the chuck 222, the printing head assembly 244, or both may have many different types of motion, potentially along more than one axis. Also, each of the chuck 222 and the printing head assembly 244 may or may not be moved while printing a line. As a result, many different patterns for the lines may be formed to overlie a substrate. FIGS. 5 to 9 include illustrations of exemplary patterns formed by a single dispense nozzle. For example, a line 524 includes a saw-tooth design, as illustrated in FIG. 5, which exemplifies a continuous line with segments that form sharp corners. In an alternative embodiment, a line 624 has a shape in the form of a sinusoidal function, as illustrated in FIG. 6. In another embodiment, a line 724 includes a curve having a negative rate of change of slope along a horizontal axis, as illustrated in FIG. 7, and a line 824 includes a curve having a positive rate of change of slope along the horizontal axis, as illustrated in FIG. 8. The relative movement of the chuck 222 and the continuous dispense nozzle may form more complex patterns over a substrate, such as a cloverleaf 924 in FIG. 9. Although not illustrated, other patterns including one or more letters, one or more numbers, one or more words, one or more symbols, one or more graphical designs, or any combination of thereof can be printed with the printing apparatus 200. In an alternative embodiment, more than one line having patterns, such as those illustrated in FIGS. 5 to 9, can be printed simultaneously by the printing apparatus 200 having a printing head with more than one nozzle or by repeatedly printing lines from a printing head having one nozzle.

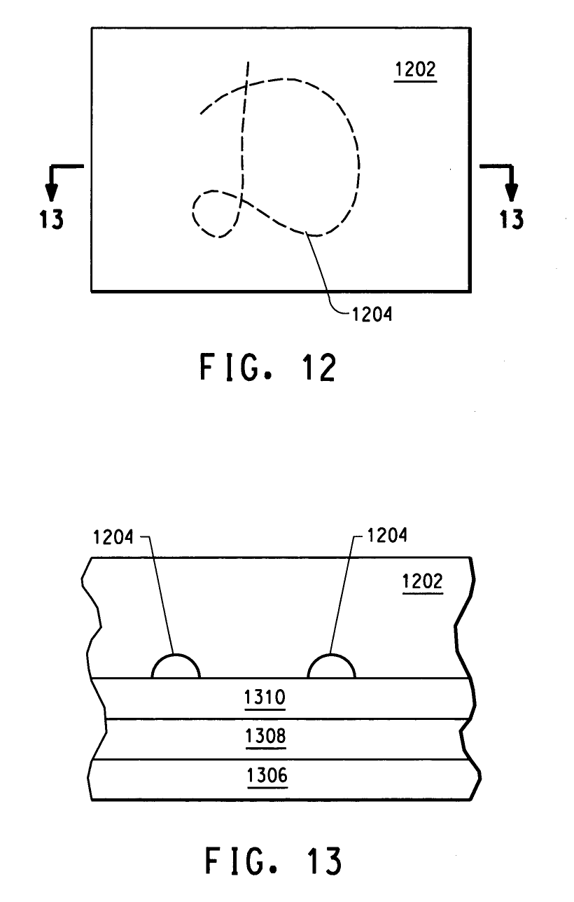

FIGS. 10 and 11 illustrate patterns of lines that can be achieved using the printing head 444 having the nozzles 445 and the pivoting mechanism 446. When printing lines using the printing head 444, the lines may be allowed to cross over or be substantially prevented from crossing over one another by proper use of the pivoting mechanism 446. For example, lines 1024, including one or more liquid compositions, may be printed over the workpiece 324 along a curve, as illustrated in FIG. 10. When the pivoting mechanism is in a fixed position, the chuck 222, the printing head 444, or both may move in directions along the x-axis and y-axis resulting in the conjoining, crossing, or overlapping of lines. Such conjoining, crossing, or overlapping of lines may or may not be desired. For example, in forming complex images, such conjoining, crossing, or overlapping may be desired. However, in another embodiment, such conjoining, crossing, or overlapping may pose a particular problem when dispensing liquid compositions that have different compositions or are associated with the emission or absorption of differing wavelengths of radiation, such as lines associated with different colors of an electronic device including a display.

In an alternative embodiment, the nozzles 445 are permitted to rotate using the pivoting mechanism 446 during printing of lines 1124, as illustrated in FIG. 11. In this exemplary embodiment, the lines do not conjoin, cross, or overlap.

5. Electronic Devices and Methods of Forming Such Electronic Devices

FIGS. 12 and 13 include illustrations of an exemplary electronic device that includes one or more electronic component(s) formed by any one or more of the apparatuses, such as those illustrated in FIGS. 1, 2, 3, and 4. FIG. 12 includes an illustration of a plan view of the exemplary electronic component. FIG. 13 includes an illustration of a cross-sectional view of the electronic component at cross-section line 13-13 of FIG. 12.

A first electrode 1308 is formed over a substrate 1306. The substrate 1306 is conventional, can include an organic or inorganic material, and may be rigid or flexible. The substrate 1306 may or may not include one or more electronic components. In one embodiment, the first electrode 1308 is an anode for the electronic component. An optional layer 1310, such as a charge injection layer, a charge blocking layer, a charge transport layer, or a combination thereof is deposited to overlie the first electrode 1308. Exemplary embodiments of the optional layer 1310 include a hole-injection layer, a hole-transport layer, an electron-blocking layer, an electron-injection layer, an electron-transport layer, a hole-blocking layer, or combinations thereof. In one embodiment, each of the substrate 1306, the first electrode 1308, and the optional layer 1310 is formed by one or more conventional techniques. Each of the layer(s) within the first electrode 1308 and the optional layer 1310 are deposited and may or may not need to be patterned. In one embodiment, the first electrode 1308 is substantially transparent to the targeted radiation wavelength or spectrum (spectra) of wavelengths to which the electronic component emits or responds. In one embodiment, the optional layer 1310 may be formed from a liquid composition using the continuous dispense apparatus as previously described.

Utilizing a continuous dispense action, a pattern of liquid composition is dispensed to form the organic active layer 1204 that overlies the optional layer 1310 and the first electrode 1308. The liquid composition may be formed using a liquid composition and continuous dispense apparatus as described above. In this exemplary embodiment as illustrated in FIGS. 12 and 13, the organic active layer 1204 is printed in a line that overlies the substrate 1306 along a curved path. In one embodiment, the organic active layer 1204 has a thickness in a range of approximately 50-100 nm. In alternative embodiments, additional organic layers, including the same or different liquid compositions, may be deposited and oriented in additional lines that overly the substrate along additional curved paths.

In this exemplary embodiment, the patterned printing of continuously dispensed liquid composition forms the organic active layer in the shape of a letter “D.” In alternative embodiments, the continuously dispensed liquid composition can form linear lines, such as straight lines, and non-linear lines, such as curved lines, saw tooth lines, circles, and complex patterns.

In one embodiment (not illustrated), another optional layer can be formed over the organic active layer 1204 before the second electrode 1202 is formed. This other optional layer can be a charge injection, charge transport, or charge blocking layer. Liquid compositions and deposition methods previously described with respect to the optional layer 1310 can be used. Note that the optional layer 1310 and the other optional layer may have the same or different compositions.

In this exemplary embodiment, a second electrode 1202 overlies the organic active layer 1204. In one exemplary embodiment, the second electrode 1202 can be a cathode. In one embodiment, the second electrode 1202 is formed by one or more conventional techniques. Each of the layer(s) within the second electrode 1202 are deposited and may or may not need to be patterned.

In alternative embodiments, additional electronic components can be formed. A set of electrodes may be located between the substrate 1306 and the organic active layer 1204. In one particular embodiment, a passive matrix device may be formed with a set of first electrodes 1308 have lengths extending in a first direction and a set of second electrodes 1202 having lengths that extend in a second direction that is substantially perpendicular to the first direction. In another particular embodiment, an active matrix device may be formed with a set of first electrodes 1308 and are individually coupled to driver circuitry (not illustrated) formed within the substrate 1306 and a single (common) second electrode 1202 that overlies the organic active layer 1204.

Other circuitry not illustrated in FIGS. 12 and 13 may be formed using any number of the previously described or additional layers. Although not illustrated, additional insulating layer(s) and interconnect level(s) may be formed to allow for circuitry in peripheral areas (not illustrated) that may lie outside the array. Such circuitry may include row or column decoders, strobes (e.g., row array strobe, column array strobe), or sense amplifiers. Alternatively, such circuitry may be formed before, during, or after the formation of any layers illustrated in FIGS. 12 and 13.

In one exemplary embodiment, a lid (not illustrated) with a desiccant (not illustrated) is attached to the substrate 1306 at locations (not illustrated) outside the array to form a substantially completed device. A gap may or may not exist between the second electrode 1202 and the desiccant. The materials used for the lid and desiccant and the attaching process are conventional.

When an exemplary display is formed as described, the organic active layer 1204 emits radiation, such as visible light, when an electric potential is applied across the second electrode 1202 and the first electrode 1308. For example, the organic active layer 1204 may be configured to emit red, green or blue light based on the liquid composition used in the formation of the organic active layer 1204.

In alternative embodiments not illustrated in FIGS. 12 and 13, additional structures may be formed over the substrate. For example, these structures may function to form channels, wells, and liquid guide structures. Such structures may be formed and patterned through know liquid deposition and patterning techniques.

In still further embodiments, other electronic device can be formed. In one embodiment, the electronic component can be a radiation-emitting component or a radiation-responsive component. The electronic component may operate within the visible light spectrum or outside of it (e.g., UV, IR, etc.).

6. Advantages

In one exemplary embodiment, an apparatus configured as described herein may be used to form complex patterns in organic active layers. The apparatus is no longer limited to straight lines. Other lines, such as curved lines, lines with sharp angles, or intersecting lines can be formed. These complex patterns may produce visually aesthetic features in a display device. For example, such display devices may be useful in emphasizing logos and branding symbols or in highlighting keys and buttons. In one particular embodiment, the apparatus may be used to print over a substrate that is free of well structure or guide structures.

Note that not all of the activities described above in the general description or the examples are required, that a portion of a specific activity may not be required, and that one or more further activities may be performed in addition to those described. Still further, the order in which activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that one or more modifications or one or more other changes can be made without departing from the scope of the invention as set forth in the claims below. Accordingly, the specification and figures are to be regarded in an illustrative rather than a restrictive sense and any and all such modifications and other changes are intended to be included within the scope of invention.

Any one or more benefits, one or more other advantages, one or more solutions to one or more problems, or any combination thereof have been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all the claims.

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

What is claimed is:

1. An apparatus comprising:
a first continuous dispense nozzle; and
a chuck configured to receive a substrate for an electronic device,
wherein the first continuous dispense nozzle, the chuck, or both are configured to move along at least two different axes during a continuous dispense action.

2. The apparatus of claim 1, wherein the at least two different axes are substantially perpendicular to each other and are substantially parallel to a plane.

3. The apparatus of claim 1, wherein the chuck is configured to move the substrate bi-directionally along the at least two different axes.

4. The apparatus of claim 1, wherein the continuous dispense action includes dispensing a liquid composition in a continuous stream.

5. The apparatus of claim 1, further comprising a head assembly including the first continuous dispense nozzle.

6. The apparatus of claim 5, wherein the head assembly includes a second continuous dispense nozzle.

7. The apparatus of claim 5, wherein the head assembly includes a pivot mechanism.

8. The apparatus of claim 1, wherein the apparatus is configured to deposit a liquid composition in a line along a curved path.

9. The apparatus of claim 1, wherein the chuck is configured to tilt.

10. A process for forming an electronic device comprising:
depositing a first line of a first liquid composition over a substrate for an electronic device, wherein depositing is performed using a continuous dispense nozzle, and wherein the continuous dispense nozzle and the substrate move relative to each other along at least two different axes during depositing.

11. The process of claim 10, wherein the at least two different axes are substantially perpendicular to each other and are substantially parallel to a plane.

12. The process of claim 10, further comprising moving the substrate bi-directionally along the at least two different axes during depositing.

13. The process of claim 10, further comprising depositing a second line to overlie the substrate.

14. The process of claim 13, wherein the first line comprises a first organic active layer, and the second line comprises a second organic active layer that has a composition different from the first organic active layer.

15. The process of claim 10, further comprising:
placing the substrate into a chuck;
moving the chuck;
moving the continuous dispense nozzle; and
wherein the depositing the first line, moving the chuck, and moving the continuous dispense nozzle occur simultaneously.

16. The process of claim 10, further comprising pivoting the continuous dispense nozzle during printing.

17. The process of claim 10, wherein depositing is performed at a travel velocity of at least 100 cm/s relative to one of the at least two axes.

18. The apparatus of claim 10, wherein the first line is oriented along a curved path.

19. An electronic device comprising:
a substrate; and
a first layer overlying the substrate wherein the first layer is oriented in a first line along a first curved path.

20. The electronic device of claim 19, further comprising a first electrode located between the substrate and the first layer and a second electrode overlying the first layer.

21. The electronic device of claim 19, further comprising a second layer overlying the substrate wherein the second layer is oriented in a second line along a second curved path, wherein the first layer and the second layer are organic active layers.
